(19) United States
(12) Patent Application Publication
(10) Pub. No.: US 2018/0063477 A1
(43) Pub. Date: Mar. 1, 2018

(54) TABLET DOCKING STATIONS AS ADAPTER FOR VIDEO CONFERENCING SYSTEM

(71) Applicant: MICROSOFT TECHNOLOGY LICENSING, LLC, Redmond, WA (US)

(72) Inventor: Mengxi Yu, Redmond, WA (US)

(73) Assignee: MICROSOFT TECHNOLOGY LICENSING, LLC, Redmond, WA (US)

(21) Appl. No.: 15/367,466

(22) Filed: Dec. 2, 2016

Related U.S. Application Data
(60) Provisional application No. 62/382,682, filed on Sep. 1, 2016.

(51) Int. Cl. H04N 7/14; H04N 7/15

(52) U.S. Cl. CPC H04N 7/147; H04N 7/142; H04N 7/15

(57) ABSTRACT

A tablet docking station configurable as adapter for video conference systems is provided. By providing suitable hardware and software interconnects, a docking station for a tablet or other portable computing device may allow a user to join a video conference through their online communication application. Interconnections in the clocking station may allow the tablet device to receive a media stream that is received at the docking station as video conference data from a video conference system. The multimedia stream may be provided to the tablet device through a serial data port. Similarly, media stream from the tablet device's serial data port may be converted to video conference data at the docking station and transmitted to the video conference system. Multiple media streams may be provided following a format of the video conference data. The tablet device and video conference system may exchange control commands through the docking station.

### CROSS-REFERENCE TO RELATED APPLICATION

This application claims priority under 35 U.S.C § 119 of U.S. Patent Provisional Application No. 62/382,682 filed on Sep. 1, 2016. The U.S. Patent Application is herein incorporated by reference in its entirety.

### BACKGROUND

Video conference systems provide a much needed functionality to users. Participants across the globe can hold meetings face-to-face, share data, make presentations, etc. without the need for multiple people to travel long distances. While video conference systems typically provide reliable and satisfactory experience to users, many such systems require sophisticated and expensive equipment.

On the other hand, multimodal, online communication applications such as Skype® and Skype For Business® by MICROSOFT CORPORATION of Redmond, Wash., provide a much more reasonable (in terms of complication and cost) alternative to expensive video conference systems. However, online communication applications are typically directed to a user experience that involves the user's computer display and its peripherals, thus, not lending itself to conference room type environments.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to tablet docking stations configurable as adapters for video conference systems. In some examples, video conference data may be received through a video data port of a docking station. The received video conference data may be converted to one or more media streams that are usable by an online communication application executed on a tablet or similar device connected to the docking station. Upon detecting an available serial data port for a tablet or similar device, the one or more media streams may be provided to the tablet or similar device through the detected serial data port.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a display diagram of an example video conference system communicatively coupled to a tablet and docking station among other devices;

FIG. 2 illustrates an example meeting device comprising a computer (tablet device), one or more displays, and a docking station configured to be an adapter for video conference systems;

FIG. 3 illustrates major functional blocks of an example docking station configured to be an adapter for video conference systems;

FIG. 4 is an example networked environment, where a system according to embodiments may be implemented;

FIG. 5 is a block diagram of an example general purpose computing device, which may be configured to work with a tablet docking station configurable as adapter for video conference systems; and

FIG. 6 illustrates a logic flow diagram of a method to utilize a tablet docking station configurable as adapter for video conference systems.

### DETAILED DESCRIPTION

As briefly described above, embodiments are directed to a tablet docking station configurable as adapter for video conference systems. By providing suitable hardware and software interconnects, a docking station for a tablet or other portable computing device may allow a user to join a video conference through their online communication application. Thus, a tablet computer may be turned instantly into a meeting device providing a familiar and instantly recognizable meeting experience for a variety of meeting spaces. Interconnections in the docking station may allow the tablet device to receive a media stream (used by the online communication application) that is received at the docking station as video conference data from a video conference system. The multimedia stream may be provided to the tablet device through a serial data port. Similarly, media stream from the tablet device's serial data port may be converted to video conference data at the docking station and transmitted to the video conference system. Multiple media streams may be provided following a format of the video conference data. The tablet device and video conference system according to some embodiments, may send commands between them through the docking station.

In the following detailed description, references are made to the accompanying drawings that form a part, hereof, and in which are shown by way of illustrations, specific embodiments, or examples. These aspects may he combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While some embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article-of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components for providing tablet docking stations configurable as adapters for video conference systems. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example embodiments may be found in the following description.

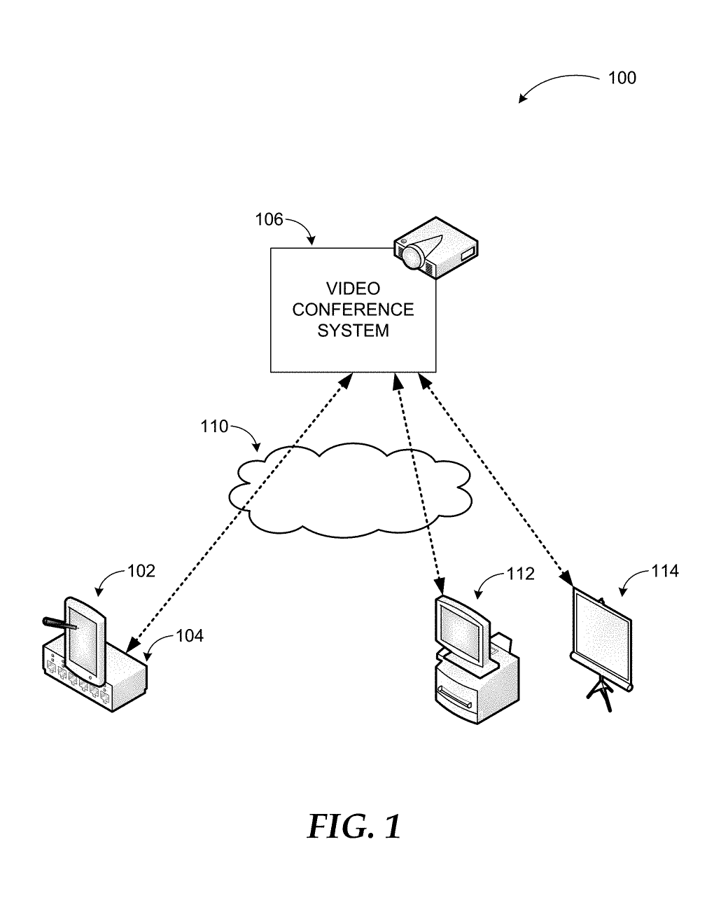

FIG. 1 illustrates a display diagram of an example video conference system communicatively coupled to a tablet and docking station among other devices, arranged in accordance with at least some embodiments described herein.

As shown in diagram 100, a tablet docking station configurable as adapter for a video conferencing system may provide suitable hardware and software interconnects to a tablet of similar computing device, thereby, allowing a user to join a video conference system 106 through their online communication application. Thus, a tablet computer 102 may be turned through a docking station 104 instantly into a meeting device providing a familiar and instantly recognizable meeting experience for a variety of meeting spaces. The user may be comfortable in the same way as they are with a dial pad. A meeting device according to example embodiments may include a computer with touch screen (e.g., a tablet device), a custom docking station to secure the computer, and audio/Video (A/V) peripherals. Interconnections in the docking station 104 may allow the tablet device 102 to receive a media stream (used by the online communication application) that is received at the docking station 104 as video conference data from a video conference system 106 over one or mere networks 110. The multimedia stream may he provided to the tablet device 102 through a serial data port. Similarly, media stream from the tablet device's serial data port may be converted to video conference data at the docking station and transmitted to the video conference system. Multiple media streams may be provided following a format of the video conference data. The video conference system 106 may also include other special purpose devices such as a specialty monitor 112 and a projection system 114, for example.

The technical advantages of a tablet docking station configurable as adapter for video conference systems may include, among others, improved performance, reduced processing and network bandwidth usage, and improved user interaction by allowing enhanced features of video conference systems to be accessible through online communication applications.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users participating in online meetings and video conference systems.

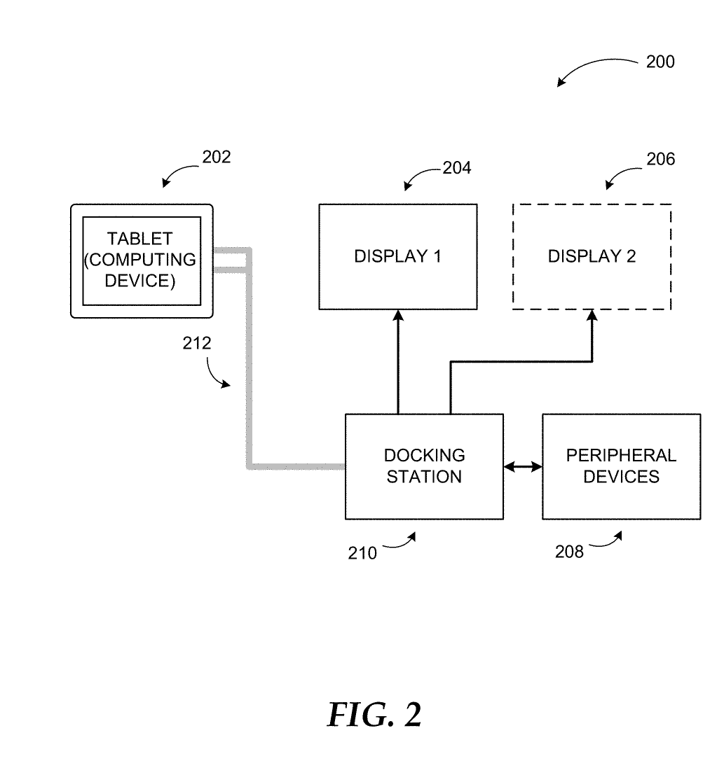

FIG. 2 illustrates an example meeting device comprising a computer (tablet device), one or more displays, and a docking station configured to be an adapter for video conference systems.

As shown in diagram 200, a meeting device according to embodiments may include a tablet or similar computing device 202 capable of executing an online communication application such as Skype® and Skype For Business® by MICROSOFT CORPORATION of Redmond, Wash. The tablet or similar computing device 202 may include one or more serial data ports such as Universal Serial Databus (USB), some of which may be capable of handling different data rates. In some operation configurations, the tablet or similar computing device 202 may be operated connected to a docking station 210, which may provide a simplified way of interconnectivity with peripheral devices 208, networks, and provide power to the tablet or similar computing device 202.

The tablet or similar computing device 202 may also be connected to one or more external displays 204, 206 through the docking station 210. A number of connections may be provided between the tablet or similar computing device 202 and the docking station 210, for example, to exchange network data communications, audio/video signals, and other control signals. In some examples, a serial bus interconnector 212 may provide the connection with the tablet or similar computing device 202.

The docking station may provide one or more video data input ports to capture video and audio outputs from external sources and comply with a number of standards. The docking station may also convert the input video data into compliant media streams and transmit to the tablet or similar device through a serial data interface. If multiple serial data ports are available, one of them may be selected based on a data rate of the generated media stream(s). The video data input may support multiple video formats and/or multiple frame rates. The serial data port connection may support a main output video stream with the resolution same as video data input port's native resolution, in some examples. In other examples, a concurrent preview video stream with scaled down resolution may also be provided. Various frame rates and compressions may be supported while video controls may be based on the standard protocol of the serial data port.

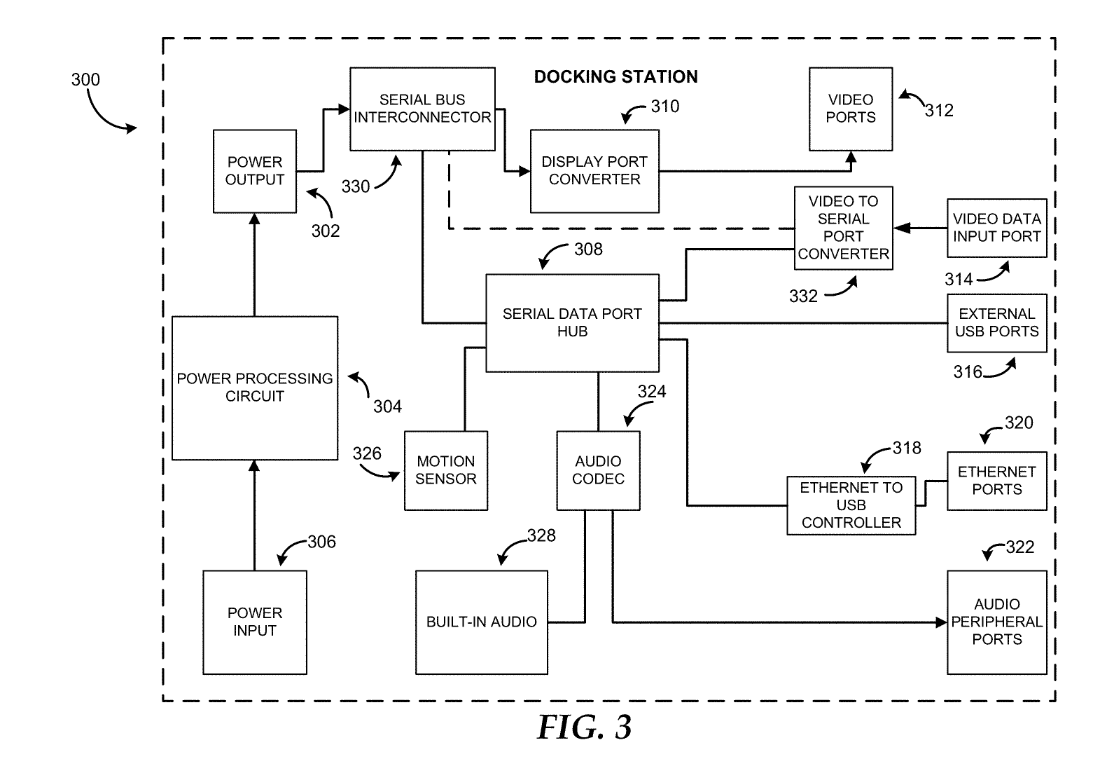

FIG. 3 illustrates major functional blocks of an example docking station configured to be an adapter for video conference systems.

The individual components of the example docking station shown in diagram 300 are for illustration purposes and are not intended to limit embodiments. Embodiments may be implemented with fewer or additional components and configurations using the principles described herein.

A docking station according to embodiments may include a power input circuit 306, a power processing circuit 304, and a power output circuit 302. The combination of the power input circuit 306, the power processing circuit 304, and the power output circuit 302 may receive powerline power, conditioned power, or battery power, process for consumption by the circuits of the docking station. In addition, power may be provided to a connected tablet or similar device through a serial bus interconnector 330, for example.

The serial bus interconnector 330 may enable exchange of data and control signals between the tablet or similar computing device and circuitry of the docking station. For example, a serial data port hub 308 may manage connections with peripherals. Connection(s) to video peripherals may be through a video data input port 314 and processed by a video to serial port converter 332. Connection(s) to audio peripherals may be provided through audio peripherals port 322 and processed by an audio codec (encoder/decoder) 324. The audio codec 324 may also process signals to and from built-in audio circuits 328. The audio codec 324 may further be used for coding or decoding the digital data stream of audio signals. Connection(s) to network data communications such as Ethernet may be through Ethernet ports 320 and processed by Ethernet to USB controller 318. The serial data port hub 308 may also manage external USB ports 316, motion sensors 326, and comparable peripherals.

Bidirectional video signal exchange may also include output signals through video ports 312 processed by a display port converter 310. Video data associated with a video conference system maybe received (and transmitted) through video ports 312 such as a high definition multimedia interface (HDMI) and processed at an HDMI to video to serial port converter 332 before being provided to the serial bus interconnector 330 via the serial data port hub 308 such as USB hub. A display port converter 310 may manage conversion of video signals from the tablet or similar computing device to external displays. While example circuitry and blocks are described using specific implementations such as USB and HDMI herein, embodiments are not limited to those and other standard or proprietary communication systems and conversions may also be implemented using the principles described here.

Unlike other data buses (e.g., Ethernet, HDMI), a serial data bus as used in a docking station according to embodiments (e.g., USB) may provide directed connections with both upstream and downstream ports emanating from a single host. If electrical power is also provided, downstream facing ports may be configured to provide power to prevent electrical overloads and damage. In converting media streams from various serial ports to video conference data (digital video data) or vice versa, the display port converter 310 and the video to serial port converter 332 may employ a number of standards. For example, standards may be used for transmission of uncompressed, unencrypted digital video signals (optionally including embedded audio and time code). Uncompressed digital component signals may be transmitted. Data maybe encoded according to a number of formats. In some examples, a linear feedback shift register may be used to scramble the data to reduce the likelihood that long strings of zeroes or ones may be present on the interface. In other examples, the interface may be self-synchronizing and self-clocking. Framing may be accomplished by detection of a special synchronization pattern, for example. Resolution, frame rate, or color fidelity may be defined according to a selected standard.

In some embodiments, the native color may be encoded according to a predefined format. A luminance channel may he encoded at full bandwidth and two chrominance channels may be subsampled horizontally, and encoded at half bandwidth (e.g., Y, Cr, and Cb). In yet other examples, a synchronization packet (timing reference signal or TRS) may occur immediately before the first active sample on every line, and immediately after the last active sample (and before the start of the horizontal blanking region). A predefined synchronization packet that includes an error correcting code may be used. In further examples, link numbering may be used in multi-link interfaces, where a primary link may be assigned a link number with subsequent links being assigned increasing link numbers. Ancillary data such as embedded audio, closed captions, timecode, and other metadata may be provided as a standardized transport for non-video .payload within a serial digital signal.

The docking station may provide a predefined number of (e.g., 2) external display output, ports for connection to external display devices. The ports may support one or more different standards, resolutions, and other connections.

The docking station may provide one or more video data input ports 314 (e.g., HDMI) to capture video and audio outputs from external sources and comply with a number of standards. The docking station may convert the input video data into compliant media streams (e.g., HDMI to UVC) and transmit to the tablet or similar device through a serial data interface. If multiple serial data ports are available, one of them may he selected based on a data rate of the generated media stream(s). The video data input may support multiple video formats, including, but not limited to, 640×480, 720×480, 800×600, 1024×768, 1280×720, 1280×800, 1280×960, 1280×1024, 1360×768, 1366×768, 1440×900, 1600×900, 1600×1200, 1680×1050, 1920×1080, 1920×1200. Multiple frame rates such as 25, 29, 97, 30, 50, 59, 94, 60 fps may also be supported.

The serial data port connection may support a main output video stream with the resolution same as video data input port's native resolution, in some examples. In other examples, a concurrent preview video stream, with scaled down (e.g., 180P) resolution may also he provided. Various frame rates and compressions may be supported while video controls may be based on the standard protocol of the serial data port. In some embodiments, the docking station may notify the tablet or similar computing device via human interface device (HID) protocol messages when an active video data input is connected or disconnected. The docking station may provide an HID interface so that the tablet or similar computing device can query the connection status of video data input. The latency of the video data to serial data (e.g., HDMI to USB) conversion may be configured to remain below a predefined threshold such as 100 ms. In some examples, the conversion may not decrypt any protected content. Audio input through the video data port may also be converted to compliant media stream(s) and transmitted to the tablet or similar computing device via the selected serial data port.

The examples provided in FIGS. 1 through 3 are illustrated with specific systems, services, applications, modules, and codes. Embodiments arc not limited to environments according to these examples. A tablet docking station configurable as adapter for video conference systems may be implemented in environments employing fewer or additional systems, services, applications, engines, codes, and user experience configurations. Furthermore, the example systems, services, applications, and modules shown in FIG. 1 through 3 may he implemented in a similar manner with other values using the principles described herein.

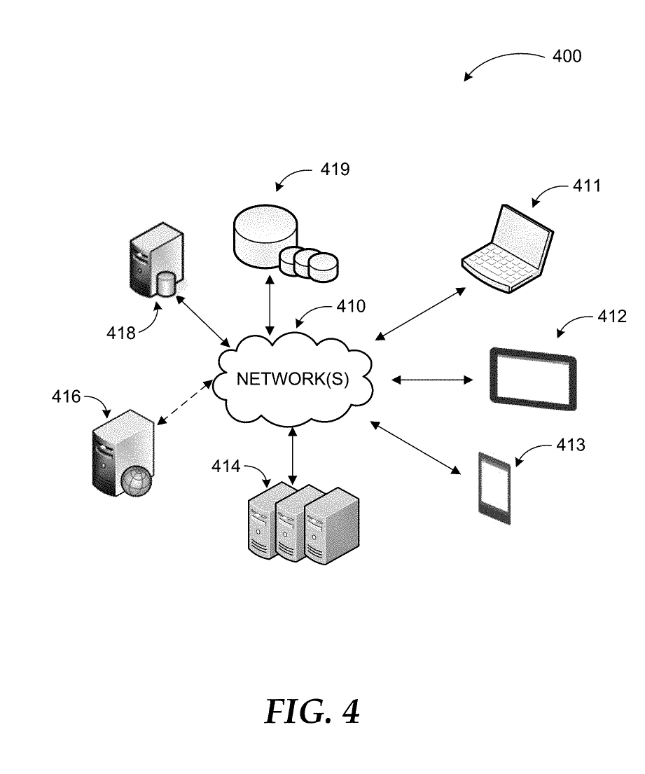

FIG. 4 is an example networked environment, where a system according to embodiments may be implemented.

As shown in a diagram 400, a video conference service may be implemented in a networked environment over one or more networks such as network 410. Users may access the service through locally installed or thin (e.g., browser) online communication client applications executed on a variety of computing devices with docking stations configured as adapters. Functionality within the video conference service environment may be provided by a communication module or application executed within the service executed on servers 414 or processing server 416.

A video conference service, as discussed herein, may be implemented via software executed over servers 414. The servers 414, may include one or more processing server 416, where at least one of the one or more processing servers 416 may be configured to execute one or more applications associated with the service. The service may store data associated with a meeting in a data store 419 directly or through a database server 418. The service may communicate with client applications on individual computing devices such as a laptop computer 411, a tablet computer 412 and a smart phone 413 through network(s) 410 and control a user interface presented to users.

The network 410 may comprise any topology of servers, clients, Internet service providers, and communication media. A system according to embodiments may have a static or dynamic topology. The network 410 may include multiple secure networks, such as an enterprise network, an unsecure network, or the Internet. The unsecure network may include a wireless open network. The network 410 may also coordinate communication over other networks, such as Public Switched Telephone Network (PSTN) or cellular networks. Furthermore, the network 410 may include multiple short-range wireless networks, such as Bluetooth, or similar ones. The network 410 may provide communication between the nodes described herein. By way of example, and not limitation, the network 410 may include wireless media. The wireless media may include, among others, acoustic media, RF media, infrared media, and other wireless media.

A textual scheme, a graphical scheme, an audio scheme, an animation scheme, a coloring scheme, a highlighting scheme, and/or a shading scheme may be employed to further enhance user interaction with a client interface of an online communication application integrated into a video conference service.

Many other configurations of the computing devices, the applications, the data sources, and the data distribution systems may be employed to provide tablet clocking stations configurable as adapters for video conference systems. Furthermore, the networked environments discussed in FIG. 4 are for illustration purposes only. Embodiments are not limited to the example applications, modules, or processes.

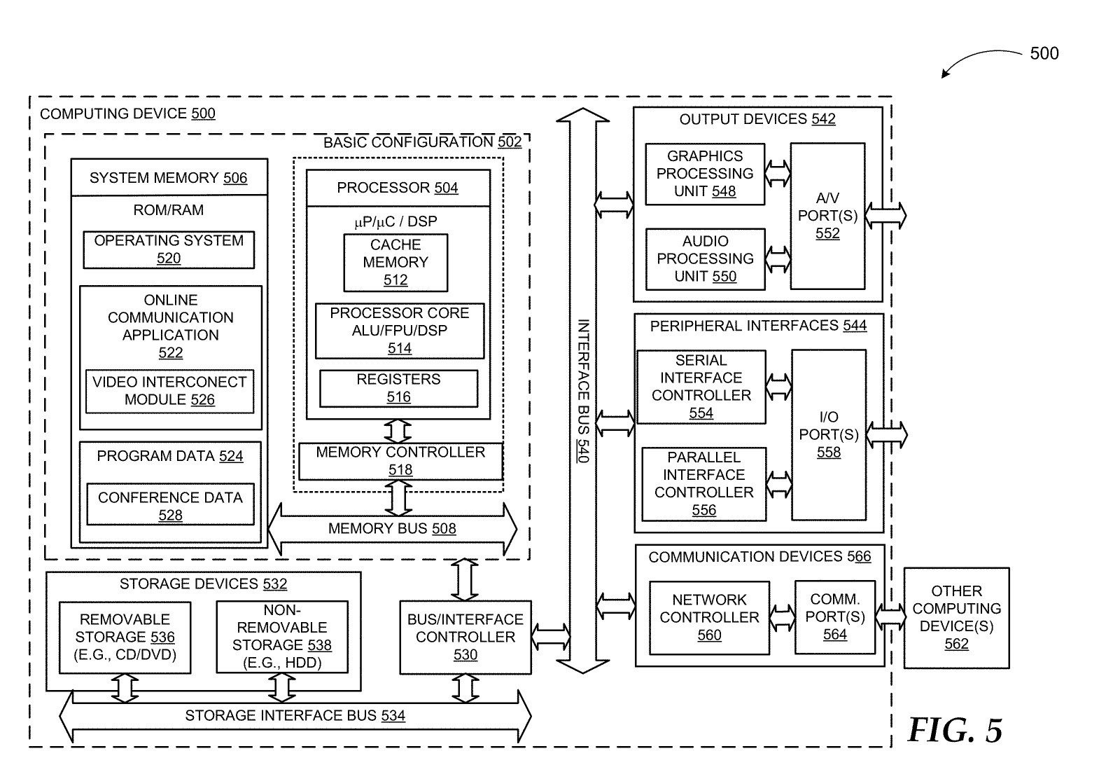

FIG. 5 is a block diagram of an example general purpose computing device, which may be configured to operate with a tablet docking station configurable as adapter for video conference systems.

For example, a computing device 500 may be a server, a desktop computer, or a special purpose device used to provide tablet docking stations configurable as adapters for video conference systems in conjunction with an online communication application 522, as discussed herein. In an example of a basic configuration 502, the computing device 500 may include a processor 504 and a system memory 506. The processor 504 may include multiple processors. A memory bus 508 may be used for communication between the processor 504 and the system memory 506. The basic configuration 502 may be illustrated in FIG. 5 by those components within the inner dashed line.

Depending on the desired configuration, the processor 504 may be of any type, including, but not limited to, a microprocessor (μP), a microcontroller (μC), a digital signal processor (DSP), or any combination thereof. The processor 504 may include one more levels of caching, such as a level cache memory 512, a processor core 514, and registers 516. The processor core 514 may include an arithmetic logic unit (ALU), a floating point unit (FPU), a digital signal processing core (DSP Core), or any combination thereof. A memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.), or any combination thereof. The system memory 506 may include an operating system 520, an online communication application 522, and program data 524. The online communication application 522 may include a video interconnect module 526. The video interconnect module 526 may perform bidirectional transformation of video conference data and media streams used by the online communication application 522 as described herein. Program data 524 may include, among others, conference data 528.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and data storage devices 532 via a storage interface bus 534. The data storage devices 532 may be removable storage devices 536, non-removable storage devices 538, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 506, the removable storage devices 536, and the non-removable storage devices 538 may he examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 566) to the basic configuration 502 via the bus/interface controller 530. The one or more output devices 542 may include a graphics processing unit 548 and an audio processing unit 550, which may be configured to communicate to various external devices, such as a display or speakers via one or more A/V ports 552. The one or more peripheral interfaces 544 may include a serial interface controller 554 or a parallel interface controller 556, which may be configured to communicate with external devices, such as input devices (for example, keyboard, mouse, pen, voice input device, touch input device, etc.) or other peripheral devices (for example, printer, scanner, etc.) via one or more I/O ports 558. The one or more communication devices 566 may include a network controller 560, which may he arranged to facilitate communications with one or more other computing devices 562 over a network communication link via one or more communication ports 564. The one or more other computing devices 562 may include servers, client equipment, and comparable devices.

The network communication link may be one example of a communication media. Communication media may be embodied by computer-readable instructions, data, structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode in formation in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 500 may be implemented as a part of a general purpose or specialized server, mainframe, or similar computer, which includes any of the above functions. The computing device 500 may also be implemented as a personal computer including both laptop computer and non-laptop computer configurations.

Example embodiments may also include methods to provide a tablet docking station configurable as adapter for video conference systems. These methods may be implemented in arty number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

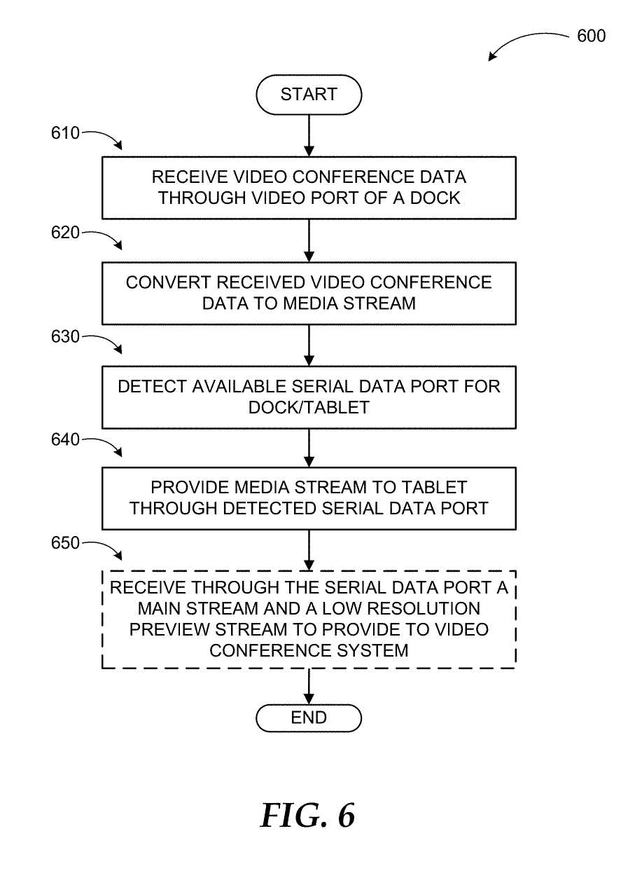

FIG. 6 illustrates a logic flow diagram for an example process to utilize a tablet docking station-configurable as adapter for video conference systems.

A process 600 may be implemented at a docking station configured to be an adapter for tablet devices and similar ones in order to allow online communication applications participate in video conferences.

At operation 610, video conference data according to a format of a video conference system may be received through a video port (e.g., HDMI) of a docking station. At operation 620, the received video conference data may be converted to a media stream that is usable by an online communication application executed on a tablet or similar device connected to the docking station.

At operation 630, an available serial data port may be detected for the tablet or similar device. If multiple serial data ports are available, one may be selected based on a data rate of the media stream. At operation 640, the media stream may be provided to the tablet or similar device through the detected/selected serial data port. At optional operation 650, one or more media streams (e.g., a main media stream and a low resolution preview media stream) may be received through the serial data port from the tablet or similar device and converted to video conference data to be provided to the video conference system.

The operations included in process 600 are for illustration purposes. A tablet docking station configurable as adapter for video conference systems, according to embodiments, may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means tor providing video conference online communication application interface through a docking station is described. The means may include a means for receiving video conference data through a video data port of the docking station; a means for converting the video conference data to one or more media streams at the docking station; a means for detecting an available serial data port to connect to a tablet device coupled to the docking station; and a means for providing the one or more media streams to the tablet device through the detected serial data port.

According to some examples, a method to provide video conference online communication application interface through a docking station is described. The method may include receiving video conference data through a video data port of the docking station; converting the video conference data to one or more media streams at the docking station; detecting an available serial data port to connect to a tablet device coupled to the docking station; and providing the one or more media streams to the tablet device through the detected serial data port.

According to other examples, the method may also include converting the one or more media streams from the tablet device through the detected serial data port to the video conference data at the docking station, and transmitting the video conference data to a video conference system. The video conference data may be transmitted to the video conference system through a video port and the video port data may be capable of handling multiple video formats.

According to further examples, the one or more media streams may be provided to the tablet device based on a format of the video conference data and the available serial data port may be detected front a plurality of serial, data ports based on a data rate of the media stream. The tablet may be connected to one or more external displays through the docking station.

According to some examples, the method may also include providing a predefined number of external display output ports for connection to the one or more external displays, exchanging control commands between the tablet device and the video conference system through the docking station, and enabling sharing of screens between the tablet device and the video conference system through the online communication application interface.

According to other examples, a docking station configured as an adapter for video conference systems to provide online communication application interface is described. The docking station may include a video data input port configured to receive a video conference data according to a format of a video conference system; a video to serial port converter configured to convert the video conference data to one or more media streams; and a serial data interface having a plurality of serial data ports to provide connectivity to the tablet device by a serial bus interconnector, wherein the serial bus interconnector is coupled to the tablet device to provide the one or more media streams to the tablet device through one of the plurality of serial data ports. The serial data port may include a Universal Serial Bus (USB) port.

According to some examples, a docking station may also include a motion sensor configured to activate an online communication application executed on the tablet device through a Human Interface Device (HID) interface, and a display port converter to convert the one or more media streams from the tablet device to video signals. The motion sensor may be configured to detect in-room human motion and awake the tablet device if it is in sleep or screen-off mode and the display port converter may be coupled to one or more external display output ports.

According to further examples, a system to provide a video conference service to a tablet device through a docking station is described. The system may include a a tablet device comprising a memory, a display, one or more input devices, and a processor, the processor configured to execute an online communication application in conjunction with instructions stored in the memory; and a docking station coupled to the tablet device through at least a serial bus interconnector. The docking station may include a communication interface configured to facilitate communication between the tablet device and the video conference service through the docking station; and a serial data port hub configured to manage exchange of signals between a plurality of docking station circuits and the tablet device. The plurality of docking station circuits may include a video to serial port converter configured to receive video conference data through a video data port of the docking station and convert the video conference data to one or more media streams, wherein the serial data port huh is further configured to detect an available serial data port to connect to the tablet device coupled to the docking station and provide the one or more media streams to the tablet device through the detected serial data port. The video to serial port converter may be configured to maintain a latency of the video conference data to serial data conversion below a predefined threshold.

According to some examples, the plurality of docking station circuits, may also include a video interconnect circuit configured to convert a media stream from the tablet device through the detected serial data port to the video conference data and transmit the video conference data to the video conference system through a video output port, and an audio codec configured to convert audio signals from the video conference system to digital signals for the tablet device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method to provide video conference online communication application interface through a docking station, the method comprising:
receiving video conference data through a video data pan of the docking station;
converting the video conference data to one or more media streams at the docking station, wherein the one or more media streams include one or more of: a main media stream and a low resolution preview media stream to be used as a preview media stream;
detecting an available serial data port to connect to a tablet device coupled to the docking station, wherein detecting the available serial data port from a plurality of serial data ports based on a data rate of one or both of the main media stream and the preview media stream; and
providing the main media stream and the preview media stream concurrently to the tablet device through the detected serial data port.

2. The method of claim 1, further comprising:
converting the one or more media streams from the tablet device through the detected serial data port to the idea conference data at the docking station; and
transmitting the video conference data to a video conference system.

3. The method of claim 2, wherein the video conference data is transmitted to the video conference system through a video port.

4. The method of claim 3, wherein the video port is capable of handling multiple video formats.

5. The method of claim 1, wherein providing the one or more media streams to the tablet device based on a format of the video conference data.

6. (canceled)

7. The method of claim 1, wherein the tablet is further connected to one or more external displays through the docking station.

8. The method of claim 7, further comprising:
providing a predefined number of external display output ports for connection to the one or more external displays.

9. The method of claim 1, further comprising:
exchanging control commands between the tablet device and the video conference system through the docking station.

10. The method of claim 1, further comprising:
enabling sharing of screens between the tablet device and the video conference system through the online communication application interface.

11. A docking station configured as an adapter for video conference systems to provide online communication application interface, the docking station comprises:
a video data input port configured to receive a video conference data according to a format of a video conference system;
a video to serial port converter configured to convert the video conference data to one or more media streams, wherein the one or more media streams include one or more of: a main media stream and a low resolution preview media stream to be used as a preview media stream; and
a serial data interface having a plurality of serial data ports to provide connectivity to the tablet device by a serial bus interconnector, wherein the serial bus interconnector is coupled to the tablet device to provide the main media stream and the preview media stream concurrently to the tablet device through one of the plurality of serial data ports based on a data rate of one or both of the main media stream and the preview media stream.

12. The docking station of claim 11, further comprising:
a motion sensor is configured to activate an online communication application executed on the tablet device through a Human interface Device (HID) interface.

13. The docking station of claim 11, wherein the motion sensor is further configured to detect in-room human motion and awake the tablet device if it is in sleep or screen-off mode.

14. The docking station of claim 11, wherein the serial data port comprises a Universal Serial Bus (USB) port.

15. The docking station of claim 11, further comprising:
a display port converter to convert the one or more media streams from the tablet device to video signals.

16. The docking station of claim 15, wherein the display port converter is further coupled to one or more external display output ports.

17. A system to provide a video conference service to a tablet device through a docking station, the system comprising:
a tablet device comprising a memory, a display, one or more input devices, and a processor, the processor configured to execute an online communication application in conjunction with instructions stored in the memory; and
a docking station coupled to the tablet device through at least a serial bus interconnector, the docking station comprising:
a communication interface configured to facilitate communication between the tablet device and the video conference service through the docking station; and
a serial data port hub configured to manage exchange of signals between a plurality of docking station circuits and the tablet device, the plurality of docking station circuits comprising:
a video to serial port converter configured to:
receive video conference data through a video data port of the docking station and convert the video conference data to one or more media streams, wherein the one or more media streams include one or more of: a main media stream and a low resolution preview media stream to be used as a preview media stream, wherein the serial data port hub is further configured to detect an available serial data port to connect to the tablet device coupled to the docking station, and wherein the available serial data port is detected from a plurality of serial data ports based on a data rate of one or both of the main media stream and the preview media stream; and
provide the main media stream and the preview media stream concurrently to the tablet device through the detected serial data port.

18. The system of claim 17, wherein the plurality of docking station circuits further comprise a video interconnect circuit configured to convert a media stream from the tablet device through the detected serial data port to the video conference data and transmit the video conference data to the video conference system through a video output port.

19. The system of claim 17, wherein the plurality of docking station circuits further comprise an audio codec configured to convert audio signals from the video conference system to digital signals for the tablet device.

20. The system of claim 17, wherein the video to serial port converter is configured to maintain a latency of the video conference data to serial data conversion below a predefined threshold.
